(19) United States
(12) Patent Application Publication
(10) Pub. No.: US 2014/0211488 A1
(43) Pub. Date: Jul. 31, 2014

(54) METHOD TO CONTROL HEADLIGHT OF VEHICLE

(71) Applicant: Caterpillar Inc., Peoria, IL (US)

(72) Inventors: RITESH SATISH GUPTA, CHENNAI (IN); SRINIVAS KOWTA, CHENNAI (IN)

(73) Assignee: Caterpillar Inc., Peoria, IL (US)

(21) Appl. No.: 14/230,283

(22) Filed: Mar. 31, 2014

(51) Int. Cl. B60Q 1/076

(52) U.S. Cl. CPC B60Q 1/076
USPC 362/464

(57) ABSTRACT

A method to control a headlight of a vehicle having a dipping control system is provided. The dipping control system includes a position detector, a map, a luminous intensity measuring device, and a controller. The method recalls the information associated with a work site and, determines a position and a direction of travel of the vehicle. Further, a position and a direction of travel of an approaching vehicle is determined and as a result the headlight of the vehicle is set in a high beam state or a low beam state. The switching of the headlight is based on work site information, whether the vehicle is approaching the other vehicle, and the vehicle and the approaching vehicle are on a trajectory of substantial intersection.

### TECHNICAL FIELD

The present disclosure relates generally to headlight control systems for use with a vehicle. More specifically, to a method to control the headlight illumination of the vehicle.

### BACKGROUND

Headlights illuminate a region in front of a vehicle allowing a driver to view the region during conditions of insufficient light. Headlights also allow drivers of approaching vehicles to see the vehicle. Headlights may be operated in high beam state or low beam state. The high beam state provides greater illumination and has a greater coverage region. However, during high beam state, the headlights may impair the vision of drivers of the approaching vehicles that enter the high beam coverage region. Headlights may switch between the high beam state and the low beam state manually or automatically.

One drawback of manual control is that the driver may forget or neglect to switch the headlights from the high beam state to the low beam state as oncoming traffic approaches. This may lead to poor visibility and inconvenience to the on-coming driver. An automatic control system or headlight “dipping system” may be used to switch the headlights between the high beam state and the low beam state based on the intensity of light. However, the existing automatic control system may generate false triggers for switching the beam state of headlights. The false triggers may be generated due to the light emanating from various sources, such as a street light, dome light, reflection, etc.

Therefore, it is desired to provide a vehicle headlight control system that can eliminate the above stated problems for switching the beam state of vehicle headlights from the high beam state to the low beam state to optimize the forward vision of the driver.

### SUMMARY OF THE DISCLOSURE

The present disclosure provides a method to control a headlight of a vehicle having a dipping control system is provided. The dipping control system comprises a position detector, a map, a luminous intensity measuring device, and a controller. The position detector is configured to determine a position and a direction of travel of the vehicle. The map is configured to have information associated with a worksite of the vehicle. The luminous intensity measuring device configured to measure the luminous intensity. The controller is configured to switch the headlight of the vehicle between a high beam state and a low beam state. The method includes a step to recall the information associated with the work site. A step to determine the position and the direction of travel of the vehicle. Another step to determine a position and a direction of travel of an approaching vehicle. Further, a step to switch the headlight of the vehicle between the high beam state and the low beam state. The switching of the headlight depends on or more of the following: work site information, at least one of the vehicle and the approaching vehicle is travelling towards the other vehicle, and the vehicle and the approaching vehicle are on a trajectory of substantial intersection.

### BRIEF DESCRIPTION OF THE DRAWING

FIG. 1 illustrates an exemplary work site, in accordance with the concepts of the present disclosure;

FIG. 2 illustrates a block diagram of a dipping control system for a headlight of a vehicle, in accordance with the concepts of the present disclosure; and

FIG. 3 illustrates a flow chart which describes a method to control the headlight of the vehicle, in accordance with the concepts of the present disclosure.

### DETAILED DESCRIPTION OF THE DRAWINGS

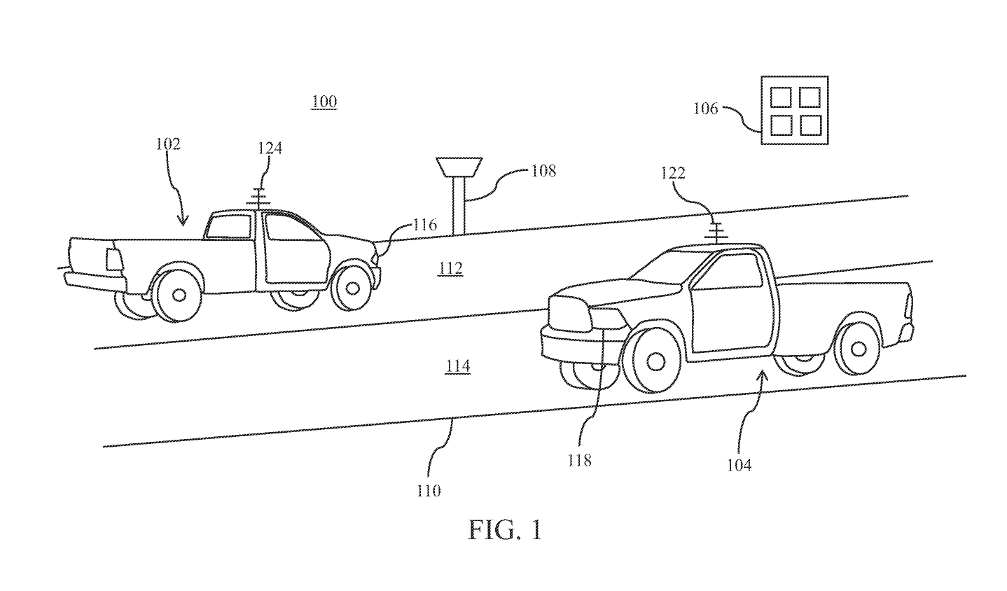

Referring to FIG. 1 an exemplary work site 100, in accordance with the concepts of the present disclosure is disclosed. The work site 100 comprises an approaching vehicle 102, a vehicle 104, a central station 106 and a stationary light-source 108. The approaching vehicle 102 and the vehicle 104 may travel on a path 110 divided into a first lane 112 and a second lane 114. The first lane 112 and the second lane 114 may contain the stationary light-source 108, positioned along the periphery of the path 110. The stationary light-source 108 may be any illuminating machine, equipment, dome light or street light, and/or the like, which is non-moving.

The approaching vehicle 102 may be a mobile machine that performs various operations associated with an industry, but not limited to mining, construction, farming, transportation, and/or the automobile industry. For example, the approaching vehicle 102 may be an earth moving machine, such as an excavator, a shovel, a backhoe, a dump truck (as shown in FIG. 1), an automobile, or a construction machine. The approaching vehicle 102 may include a headlight 116 to illuminate a region in front of the approaching vehicle 102.

The vehicle 104 may be a mobile machine that performs various operations associated with an industry, such as, but not limited to, mining, construction, farming, transportation, and/or the automobile industry. For example, the vehicle 104 may be an earth moving machine, such as an excavator, a shovel, a backhoe, a dump truck (as shown in FIG. 1), an automobile, or a construction machine. The vehicle 104 may be a vehicle travelling in the direction opposite to the direction of travel of the approaching vehicle 102. The vehicle 104 may travel in the lane of travel of the approaching vehicle 102 or may travel in the lane which is different than the lane of travel of the approaching vehicle 102.

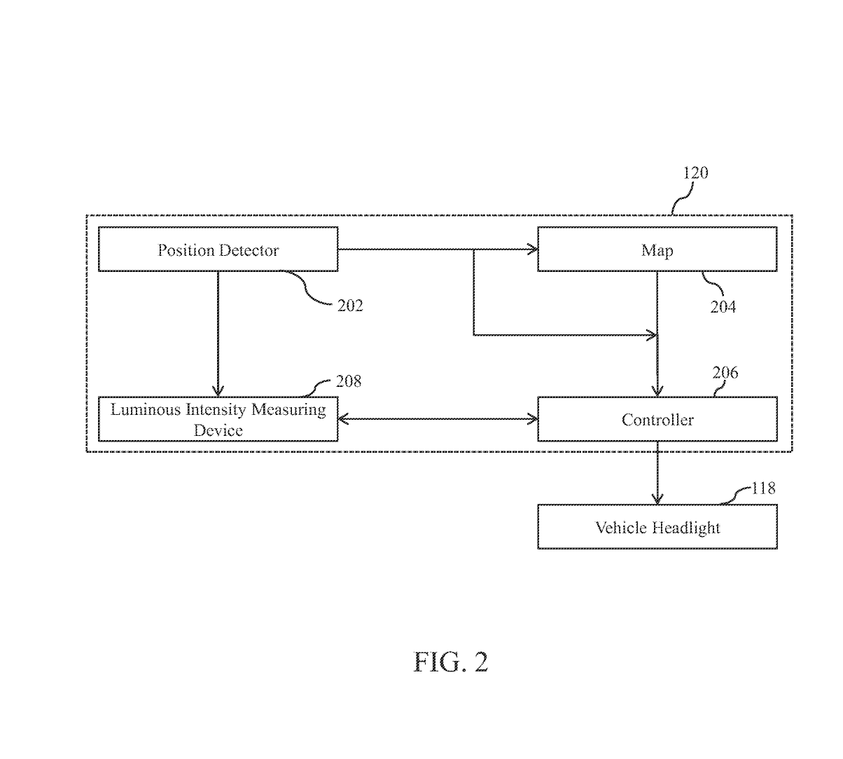

The vehicle 104 has a pair of headlights 118 (one is shown in FIG. 2), an electronically controlled dimmer system or dipping control system 120 (FIG. 2), and a communication system 122. The headlight 118 of the vehicle 104 has the ability to operate in a high beam state and a low beam state.

The dipping control system 120 switches the headlight 118 of the vehicle 104 between the high beam state and the low beam state.

The communication system 122 may be configured to transmit and/or receive any information to and/or from the vehicle 104. The information may include, but is not limited to, a location, an operating state of headlight 118 of the vehicle 104, and/or an instruction set for the dipping control system 120. The communication system 122 may be a local area system, a satellite system, a mobile network system, and/or the like. The communication system 122 may further enable the vehicle 104 to establish a continuous link with the central station 106. In an embodiment, the approaching vehicle 102 may also include a second communication system 124 similar to the communication system 122. The second communication system 124 may also enable the approaching vehicle 102 to establish a continuous link with the central station 106.

The central station 106 is a centralized unit located at a predefined location on the work site 100. The central station 106 may monitor operations on the work site 100 and include a transmitter (not shown), a receiver (not shown) and an operational unit (not shown) as is customary.

Referring to FIG. 2 a block diagram of the dipping control system 120 will be described. The dipping control system 120 may include a position detector 202, a map 204, a controller 206, and a luminous intensity measuring device 208.

The position detector 202 determines a position and a direction of travel of the vehicle 104. Examples of the position detector 202 may include, but are not limited to, a global positioning system, an inertial measurement unit, and/or a global navigation satellite system. The position detector 202 may provide the position and the direction of travel of the vehicle 104 to the map 204.

The map 204 provides information relative to the work site 100, for example, in a graphical format. Such information may include: location of the stationary light-source 108, objects to avoid within or near the work site 100, and information regarding the approaching vehicle 102 such as vehicle position, direction of travel and trajectory information (e.g.: driving lane of the approaching vehicle 102). The map 204 may possess the capability to provide a real-time update regarding any important informational change such as changes to the work site 100. The map 204 may further be in communication with the controller 206.

The controller 206 processes the information available from the map 204 as will now be described. The controller 206 determines the position and the direction of travel of the approaching vehicle 102 and if the approaching vehicle 102 is travelling towards the vehicle 104 from an opposite direction of travel, the controller 206 may activate the luminous intensity measuring device 208.

The luminous intensity measuring device 208 measures a luminous intensity of the approaching vehicle 102 and compares the measured luminous intensity with a predefined luminous intensity.

The luminous intensity measuring device 208 may communicate the measured luminous intensity to the controller 206, and/or to the communication system 122. The communication system 122 may transmit the measured luminous intensity to the central station 106. The controller 206 and/or the central station 106 may then compare the measured luminous intensity with the predefined luminous intensity.

The predefined luminous intensity defines a threshold limit. If the measured luminous intensity is above the threshold limit, the controller 206 may be enabled to generate a control signal for the dipping control system 120. Based on the control signal, the dipping control system 120 may switch the headlight 118 of the vehicle 104 from the high beam state to the low beam state or from the low beam state to the high beam state.

In an embodiment, the position detector 202 of the dipping control system 120 provides the position and the direction of travel of the vehicle 104 to the communication system 122. The communication system 122 may then transmit the received information to the central station 106. Within the same embodiment, the central station 106 receives the similar information from other vehicles that move in the work site 100. The central station 106 further processes the received information and aligns the received information with the map 204. The map 204 provides a platform to the central station 106 for collating the received information and determining the relative position of the vehicle 104 with the other vehicles on the work site 100. In another embodiment, the position detector 202 provides only the position of the vehicles to the central station 106. The position information is provided in terms of latitudinal and longitudinal co-ordinates. The central station 106 updates the map 204 continuously based on this information. Based on the information the central station 106 determines the direction of travel of different vehicles, lane of travelling, relative position of the vehicles and the like. Further, the central station 106 determines when the vehicle 104 is approximating or about to cross another vehicle that may be the approaching vehicle 102 based on the information disclosed above in the document. The approaching vehicle 102 is travelling in the direction opposite to the direction of travel of the vehicle 104. Upon determination, the central station 106 generates a signal and transmits the signal to the communication system 122 of the vehicle 104. After receiving the signal, the communication system 122 after receiving the signal initiates the controller 206. The controller 206 further activates the luminous intensity measuring device 208. The luminous intensity measuring device 208 measures the luminous intensity of the approaching vehicle 102. The measured luminous intensity is then communicated to the controller 206. In an embodiment, the controller 206 compares the luminous intensity with the threshold limit. If the measured luminous intensity is greater than the threshold limit, the controller 206 generates the control signal for the dipping control system 120. Based on the control signal, the dipping control system 120 may switch the headlight 118 of the vehicle 104 from the high beam state to the low beam state or from the low beam state to the high beam state. In another embodiment, the controller 206 after receiving the measured luminous intensity transmits the information to the central station 106 via communication system 122. The central station 106 after receiving the measured luminous intensity compares the measured luminous intensity with the threshold limit. If the measured luminous intensity is greater than the threshold limit the central station 106 transmits a signal to the vehicle 104. The signal is received by the communication system and the transferred to the controller 206. The controller based on the signal activates the dipping control system 120 to switch the headlight 118 of the vehicle 104 from the high beam state to the low beam state or from the low beam state to the high beam state.

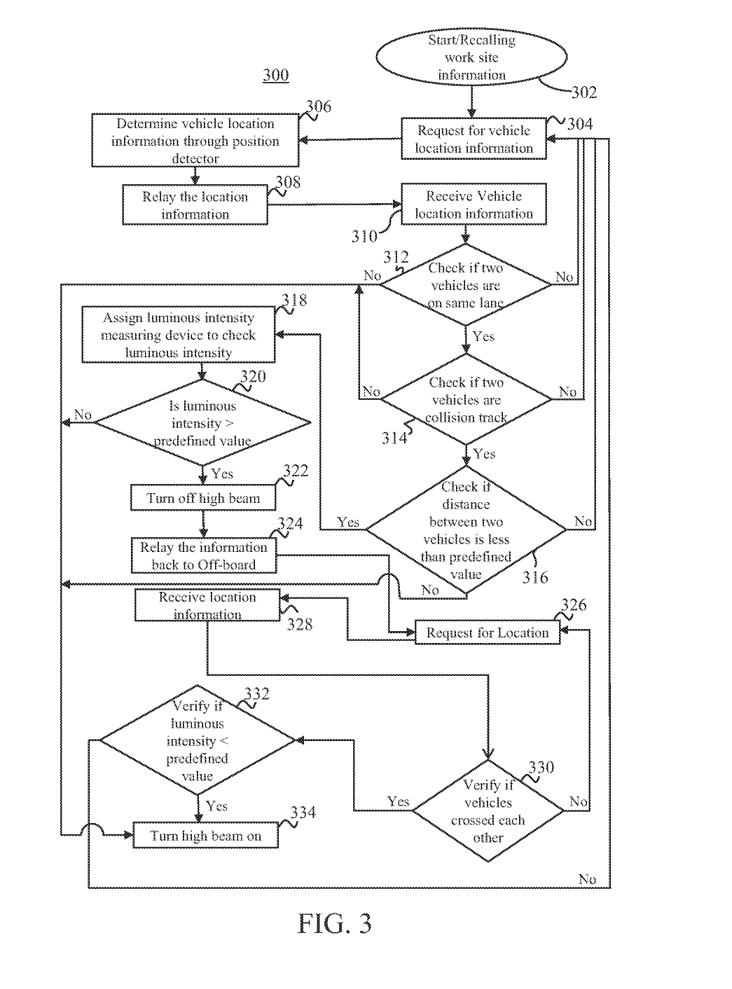

Referring to FIG. 3 a flow chart 300, describing a method to control the headlight 118 of the vehicle 104, will be described. At step 302 the method calls for the work site information. The method after step 302 proceeds to step 304.

At step 304, a request may be raised for the location information associated with the vehicle 104 and the approaching vehicle 102. Once the request is raised, the method proceeds to step 306.

At step 306, location information associated with the vehicle 104 and the approaching vehicle 102 is determined. The location may be determined using the position detector 202. The method then proceeds to step 308.

At step 308, the location information determined in step 306 may be relayed to the dipping control system 120. The method then proceeds to step 310.

At step 310, the location information is received by the dipping control system 120 and the method proceeds to step 312.

At step 312, the method determines if the vehicle 104 and the approaching vehicle 102 are positioned for intersecting trajectories or in the same lane. If the two vehicles are not in the same lane, the method moves back to step 304 and further, the method proceeds to step 334. The dipping control system 120 may sustain the illumination of the headlight 118 of the vehicle 104 so that it remains in the high beam state. If the two vehicles are in the same lane the method proceeds to step 314.

At step 314, the method determines if the vehicle 104 and the approaching vehicle 102 are on a collision track. The collision track refers to the lane of travel when the vehicle 104 and the approaching vehicle 102 are travelling in the same lane but in opposite direction. If the two vehicles are not on the collision track the method moves simultaneously to step 304 and step 334. If the two vehicles are on the collision track the method proceeds to step 316.

At step 316, the method determines the distance between the two vehicles. If the distance between the two vehicles is more than a predefined value, the method moves simultaneously to step 304 and step 334. If the distance between the two vehicles is less than the predefined value the method proceeds to step 318.

At step 318, the luminous intensity measuring device 208 measures the luminous intensity of an approaching vehicle 102. The method then proceeds to step 320.

At step 320, the luminous intensity of the approaching vehicle 102 is determined. If the luminous intensity of the approaching vehicle 102 is less than a predefined value, the method moves to step 334. If the luminous intensity of the approaching vehicle 102 is more than the predefined value, the method moves to step 322.

At step 322, the dipping control system 120 is enabled to change the headlight 118 of the vehicle 104 from the high beam state to the low beam state. The method then proceeds to step 324.

At step 324, information associated with the headlight 118 of the vehicle 104 is relayed to the central station 106. The method then proceeds to step 326.

At step 326, the location information associated with the vehicle 104 is again requested and then proceeds to step 328.

At step 328, the dipping control system 120 receives the location information associated with the vehicle 104. The method then proceeds to step 330.

At step 330, the method verifies that two vehicles have passed each other. If the two vehicles have not passed each other the method moves to step 326. If the two vehicles have passed each other the method proceeds to step 332.

At step 332, the luminous intensity in front of the vehicle 104 is verified again. If the luminous intensity is greater than the predefined value the method moves to step 304. If the luminous intensity is less than the predefined value the method moves to step 334.

At step 334, the dipping control system 120 may be enabled to change the headlight 118 of the vehicle 104 from the low beam state to the high beam state. The method may conclude at step 334.

At all times while the headlight 118 of the vehicle 104 is on and the vehicle 104 is moving, the dipping control system 120 of the vehicle 104 continuously executes this method.

### Industrial Applicability

While travelling on a road or in a work site 100, vehicles such as the approaching vehicle 102 and the vehicle 104 are moving between locations within the site. When the vehicle 104 and the approaching vehicle 102 are travelling in the opposite directions and approaching one another the use of headlight 118 of vehicle 104 in the high beam state may produce glare to the approaching vehicle 102, which may be an inconvenience to the driver of the approaching vehicle 102. However, with dipping control system 120, the beam illumination controlling the headlight 118 of the vehicle 104 is enacted. The position detector 202 of dipping control system 120 provides the position and the direction of travel of the vehicle 104. After determining the position and the direction of travel of the vehicle 104, the dipping control system 120 relays the position and the direction of travel of the vehicle 104 to the communication system 122 and the map 204. The map 204, having the ability to update in real time with information about the work site 100, transmits information about the work site 100 to the controller 206. If the controller 206 determines the approaching vehicle 102 is travelling in same lane and coming from opposite direction towards the vehicle 104, the luminous intensity measuring device 208 is enabled to measure the luminous intensity of the approaching vehicle 102. If the measured luminous intensity of the approaching vehicle 102, based on whether it is greater than a predefined value programmed into the controller 206, the high beam is switched off by the controller 206. If luminous intensity of the approaching vehicle 102 is lower than the predefined value, the high beam is left on.

What is claimed is:

1. A method to control a headlight of a vehicle having a dipping control system, the dipping control system further includes a position detector configured to determine a position and a direction of travel of the vehicle, a map configured to have information associated with a worksite of the vehicle, a luminous intensity measuring device configured to measure the luminous intensity, and a controller configured to switch the headlight of the vehicle between a high beam state and a low beam state, wherein the method comprising the steps of:
recalling the information related with the work site;
determining the position and the direction of travel of the vehicle;
determining a position and a direction of the travel of an approaching vehicle; and
switching the headlight of the vehicle between the high beam state and the low beam state based on:
work site information;
at least one of the vehicle and the approaching vehicle is travelling towards the other vehicle; and
the vehicle and the approaching vehicle are on a trajectory of substantial intersection.
